(19) United States
(12) Patent Application Publication
(10) Pub. No.: US 2007/0159564 A1
(43) Pub. Date: Jul. 12, 2007

(54) Thin film transistor substrate of liquid crystal display and method for fabricating the same

(75) Inventors: Tzu-Min Yan, Miao-Li (TW); Chien-Ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,043

(22) Filed: Dec. 18, 2006

(30) Foreign Application Priority Data
Dec. 16, 2005 (TW) 94144820

(51) Int. Cl. G02F 1/1343

(52) U.S. Cl. 349/38

(57) ABSTRACT

A portion of an exemplary thin film transistor substrate (200) of a liquid crystal display includes a substrate (201), a gate line (210), a data line (220), and a storage line (250). The gate line, the data line, and the storage line are formed on the substrate. A gate insulating layer (202) is formed on the gate line, the storage line, and the substrate. A pixel electrode (240) is formed at the gate insulating layer. The storage line cooperates with the pixel electrode to form a storage capacitor. The gate line includes a first metal layer (211), and a second metal layer (212) formed on the first metal layer.

### FIELD OF THE INVENTION

The present invention relates to thin film transistor substrates of liquid crystal displays, and more particularly to a thin film transistor substrate of a liquid crystal display configured to provide reflection ability by a storage line thereof.

### BACKGROUND

A typical liquid crystal displays (LCD) includes a display panel and a backlight unit. The display panel includes a substrate with a plurality of thin film transistors, a substrate with color filters, and a liquid crystal layer interposed therebetween. The thin film transistors control pixel electrodes disposed on the thin film transistor substrate.

Referring to FIG. 18, this shows a top view of a part of a thin film transistor substrate 100 of a conventional liquid crystal display. The thin film transistor substrate 100 includes a plurality of gate lines 110, a plurality of data lines 120, and a plurality of storage lines 150. The gate and data lines 110, 120 are insulated from and cross each other, and cooperatively define a plurality of pixel units (not labeled). Each pixel unit includes a pixel electrode 140 and a thin film transistor 130. The thin film transistor 130 is formed adjacent to a respective intersection of the gate and data lines 110, 120 and includes a gate 131, source 132, and a drain 133. The gate 131 is connected to the gate line 110, the source 132 is connected to the data line 120, and the drain 133 is connected to the pixel electrode 140. A driving circuit (not shown) charges the pixel electrode 140 through the data line 120 when the source 132 is connected with the drain 133 as the gate 131 has been enabled. The storage line 150 is substantially parallel to the gate line 110 and insulated from and overlapped with a part of the pixel electrode 140, thereby forming a storage capacitor for retaining a voltage of the pixel electrode 140 after thereof is charged.

Referring to FIG. 19, this shows a cross-sectional view of the thin film transistor substrate 100. The thin film transistor substrate 100 includes a substrate 101, the gate 131, the storage line 150, a gate insulating layer 102, a semiconductor layer 103, a passivation layer 104, and the pixel electrode 140.

The gate 131 and the storage line 150 are formed on the substrate 101 respectively. The insulating layer 102 is formed on the gate 131, the storage line 150, and the substrate 101 insulating the gate 131 from the storage 150. The semiconductor layer 103 is formed on the gate insulating layer 102 at position according to the gate 131. The source 132 and the drain 133 are independently formed on the each side of semiconductor layer 103. The passivation layer 104 is formed on the source 132, semiconductor layer 103, drain 133, and the gate insulating layer 102. The pixel electrode 140 is made from indium tin oxide (ITO) formed on the passivation layer 104 and electrically contacted to the drain 133 via a through hole 105. The pixel electrode 140 and the storage line 150 together define the storage capacitor.

A connecting line made from ITO connects the gate line 110 with the driving circuit. The gate line 110 and the storage line 150 are formed at a same step during fabricating thereof, and are both made form molybdenum, and because molybdenum is not reacted with the ITO; therefore, a chemical reaction between the gate line 110 and the connecting line can be avoided.

However, molybdenum is opaque material and has low reflection ability, thus, environment light cannot be reflected by thereof efficiently, and a brightness of the liquid crystal display is decreased.

Accordingly, what is needed is a thin film transistor substrate of a liquid crystal display configured to overcome the above-described problems.

### SUMMARY

An exemplary thin film transistor substrate of a liquid crystal display includes a substrate, at least one gate line, at least one data line, and at least one storage line. The at least one gate line, at least one data line, and the at least one storage line are formed on the substrate. A gate insulating layer formed on the at least one gate line, on the at least one storage line, and on the substrate. A pixel electrode is formed at the gate insulating layer. The at least one storage line cooperatives with the pixel electrode to form a storage capacitor, and the at least one gate line includes a first metal layer, and a second metal layer formed on the first metal layer.

A detailed description of embodiments of the present invention is given below with reference to the accompanying drawings.

### BRIEF DESCRIPTION OF THE DRAWINGS

In the drawings, all the views are schematic.

FIG. 1 is a top view of a part of a thin film transistor substrate of a convention liquid crystal display in accordance with the preferred embodiment of the present invention.

FIG. 2 is a cross-sectional view of the thin film transistor substrate of FIG. 1, taken along line II-II.

FIG. 3 is a flow chart of steps of fabricating a thin film transistor substrate.

FIG. 4 is a cross-sectional view of a substrate with two metal layers and a first photoresist layer.

FIG. 5 is a cross-sectional view of a cross-sectional view of the first photoresist layer with a first photo-mask.

FIG. 6 is a cross-sectional view of two patterned first photoresist layers.

FIG. 7 is a cross-sectional view of the patterned first photoresist layer with a patterned first metal layer and the patterned second metal layer.

FIG. 8 is a cross-sectional view of two sets of the first metal layer and the second metal layer, and one is covered by a first photoresist layer.

FIG. 9 is a cross-sectional view of a storage line and a gate having two layers.

FIG. 10 is a cross-sectional view of a gate, a storage line, a gate insulating layer, a doped amorphous silicon layer, and a second photoresist layer.

FIG. 11 is a cross-sectional view of a semiconductor layer formed on the gate insulating layer.

FIG. 12 is a cross-sectional view of a metal layer and a third photoresist layer formed on the semiconductor layer.

FIG. 13 is a cross-sectional view of a source and a drain formed on the semiconductor layer.

FIG. 14 is a cross-sectional view of a passivation layer and a fourth photoresist layer formed on the source, semiconductor, drain, and the gate insulating layer.

FIG. 15 a cross-sectional view of is the passivation layer with a through hole.

FIG. 16 is a cross-sectional view of a transparent and conductor metal layer and a fifth photoresist layer formed on the passivation layer.

FIG. 17 is the substrate with a pixel electrode.

FIG. 18 is a top view of a part of a thin film transistor substrate of a convention liquid crystal display.

FIG. 19 is a cross-sectional view of the thin film transistor substrate of FIG. 18, taken along line XIX-XIX.

### DETAILED DESCRIPTION OF PREFERRED EMBODIMENTS

Referring to FIG. 1, this shows a top view of a part of a thin film transistor substrate 200 of a liquid crystal display in accordance with a preferred embodiment of the present invention. The thin film transistor substrate 200 includes a plurality of gate lines 210, a plurality of data lines 220, and a plurality of storage lines 250. The gate and data lines 210, 220 are insulated from and cross each other, and cooperatively define a plurality of pixel units (not labeled). Each pixel unit includes a pixel electrode 240 and a thin film transistor 230. The thin film transistor 230 is formed adjacent to a respective intersection of the gate and data lines 210, 220, and includes a gate 231, source 232, and a drain 233. The gate 231 is connected to the gate line 210, the source 232 is connected to the data line 220, and the drain 233 is connected to the pixel electrode 240. A driving circuit (not shown) charges the pixel electrode 140 through the data line 120 when the source 132 is connected with the drain 133 as the gate 131 has been enabled. The storage line 250 is substantially parallel to the gate line 210 and insulated from and overlapped with a part of the pixel electrode 240, thereby forming a storage capacitor for retaining a voltage of the pixel electrode 140 after thereof is charged.

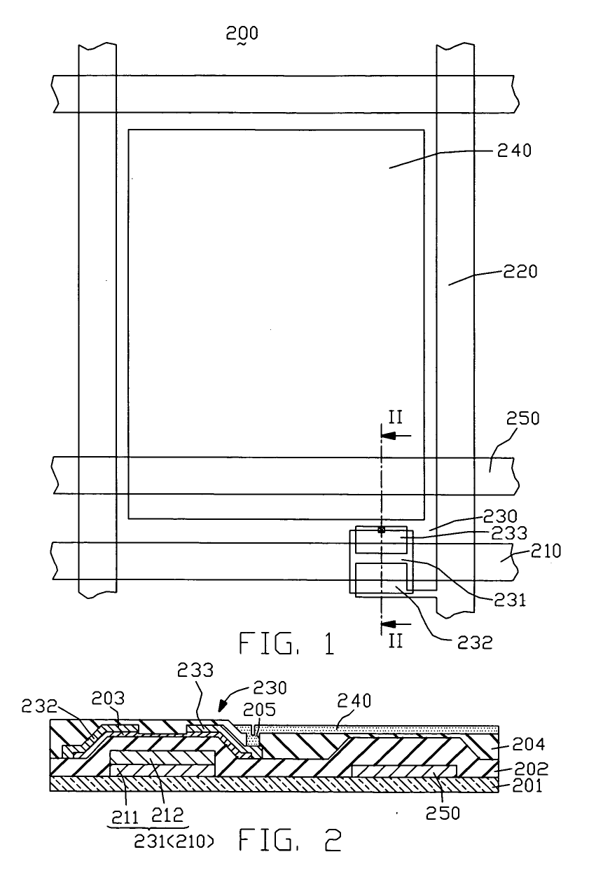

Referring to FIG. 2, this shows a cross-sectional view of the thin film transistor substrate 200 of FIG. 1, taken along line II-II. The thin film transistor substrate 200 includes a substrate 201, the storage line 250, the gate 231, a gate insulating layer 202, a semiconductor layer 203, a source 232, a drain 233, a passivation layer 204, and the pixel electrode 240.

The gate 231 and the storage line 250 are formed on the substrate 201 respectively. The gate insulating layer 202 is formed on the gate 231, the storage line 250, and the substrate 201 insulating the gate 231 and the storage 250. The semiconductor layer 203 is formed on the gate insulating layer 202 at position according to the gate 231. The source 232 and the drain 233 are independently formed on the each side of the semiconductor layer 203. The passivation layer 204 is formed on the source 232, semiconductor layer 203, drain 233, and the gate insulating layer 202. The pixel electrode 240 is made from indium tin oxide (ITO) or indium zinc oxide (IZO), and is formed at the passivation layer 204 and electrically contacted with the drain 233 via a through hole 205. The pixel electrode 240 and the storage line 250 together define the storage capacitor.

The gate 231 and the gate line 210 both are double-layer structure including a first metal layer 211, and a second metal layer 212 formed on thereof. The thickness of the first metal layer 211 is substantially equal to the storage line 250. A connecting line (not shown) made from ITO or IZO connects the gate 231 with the driving circuit. The first metal 211 and the storage line 250 are formed at a same step during fabricating thereof, and are both made from metal which has high reflection ability, such as silver, aluminum, or aluminum-neodymium alloy. The second metal 212 is made from molybdenum, chromium, or titanium, which does not chemically react with ITO or IZO under normal temperatures and pressures. Therefore, chemical reaction between the gate line 210 and the connecting line can be avoided.

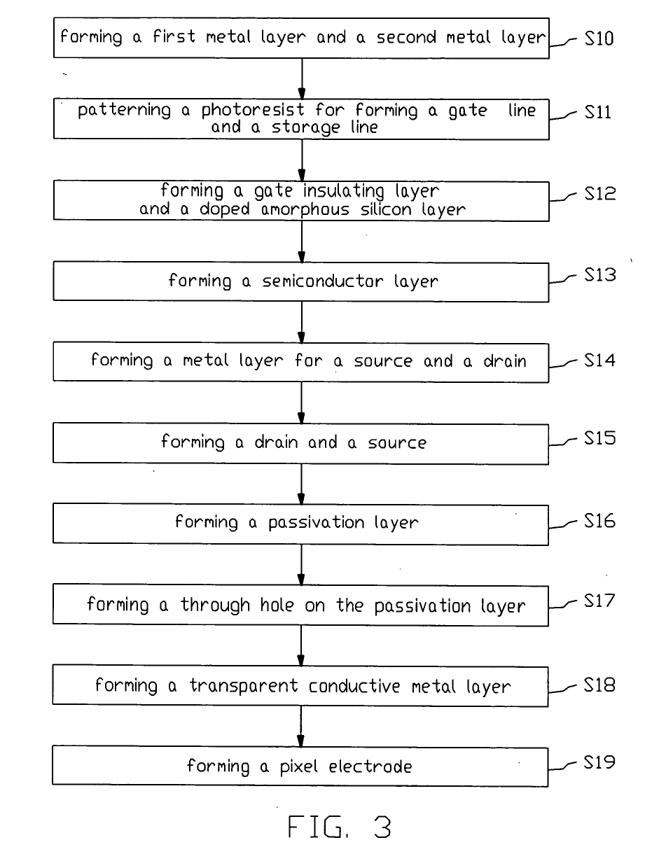

Referring to FIG. 3, this shows a flow chart of steps of fabricating a thin film transistor substrate. The steps using five photo-mask processes are described as follows.

A first photo-mask process is described as follows.

In step S10, a first metal layer and a second metal layer are formed.

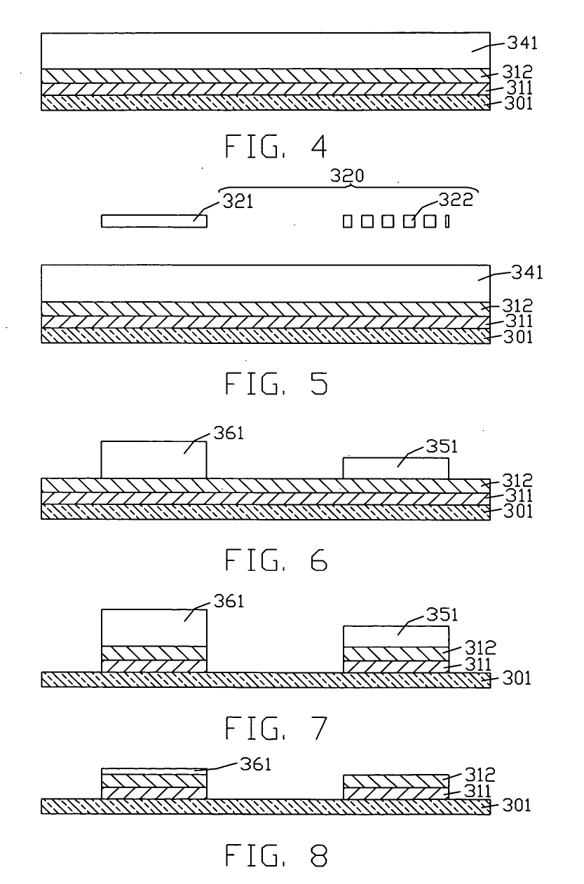

Referring to FIG. 4, a substrate 301 made from insulating material, such as, glass, quartz or porcelain, is first provided. The first metal layer 311 made from metal with high reflection ability, such as, silver, aluminum, or aluminum-neodymium alloy, is deposited on the substrate 301. The second metal layer 312 made from molybdenum, chromium, or titanium, which does not chemically react with ITO or IZO under normal temperatures and pressures, is deposited on the first metal 311 layer. A first photoresist layer 341 is deposited on the second metal layer 312.

In step S11, the first photoresist layer 341 is patterned for forming a gate and a storage line.

Referring to FIG. 5, a first photo-mask 320 is arranged above the first photoresist layer 341 including a first region 321, and a second region 322 having a plurality of slits. An ultraviolet (UV) ray light source is used for developing the first photoresist layer 341 with the first photo-mask 320 to form a pattern for the gate and the storage line shown in FIG. 6.

Referring to FIG. 6, because different exposure at the first and second regions 321, 322; therefore, resulting a thin photoresist layer 351 at a position according to the second region 322 which is thinner than a thick photoresist layer 361 at the first region 321.

Referring to FIG. 7, a pattern of the first and second metal layers 311, 312 is shown. The first and second metal layers 311, 312 are etched to form a pattern of where the thin and thick photoresist layers 351, 361 are covered.

Referring to FIG. 8, an etching process for removing the thin and thick photoresist layers 351, 361. An etching process is controlled to remove the thin photoresist layer 351, and a thin profile of the thick photoresist layer 361 on the second metal layer 312 is remained thereon.

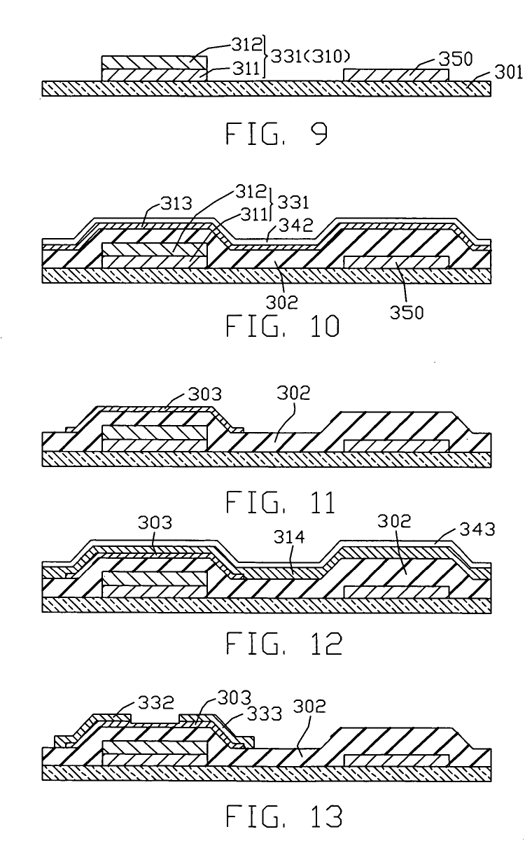

Referring to FIG. 9, the second metal layer 312 not covered by the thick photoresist layer 361 is etched out, then, removing the residual thick photoresist layer 361. A pattern of the gate 331 or a gate line 310 both are double-layer structure which includes first and second metal layers 311, 312 and the storage line 350.

A second photo-mask process is described as follows.

In step S12, a gate insulating layer, and a doped amorphous silicon layer are formed.

Referring to FIG. 10, a gate insulating layer 302 is formed on the substrate 301, the gate 331, and the storage line 350. The gate insulating layer 302 is formed by chemical vapor deposition using silicon nitride with a reaction gas, such as, SiH4, NH3. An amorphous silicon layer is formed by chemical vapor deposition on the gate insulating layer 302. The amorphous silicon layer is doped with impurity ions forming a doped amorphous silicon layer 313. A second photoresist layer 342 is formed on the doped amorphous silicon layer 313.

In step S13, a semiconductor layer is formed.

Referring to FIG. 11, a second photo-mask is arranged above the second photoresist layer 342. An ultraviolet ray light source is used for developing the second photoresist layer 342 with the second photo-mask to form a pattern as a semiconductor layer, and then, the doped amorphous silicon layer 313 is etched to form a semiconductor layer 303 with a pattern shown in FIG. 11. Afterward, the second photoresist layer 342 is removed.

A third photo-mask process is described as follows.

In step S14, a metal layer for source and drain is formed.

Referring to FIG. 12, a metal layer 314 is deposited on the semiconductor layer 303. The metal layer 314 is made from molybdenum or molybdenum alloy is deposited on the semiconductor layer 303 and the gate insulating layer 302. A third photoresist layer 343 is deposited on the metal layer 314.

In step S15, a drain and a source are formed independently.

Referring to FIG. 13, a third photo-mask is arranged above the third photoresist layer 343. An ultraviolet ray light source is used for developing the third photoresist layer 343 with the third photo-mask to form a pattern, then, the metal layer 314 is etched to form a source 332 and a source 333 at each side of the semiconductor layer 303 independently. Afterward, the third photoresist layer 343 is removed.

A fourth photo-mask process is described as follows.

In step S16, a passivation layer is formed.

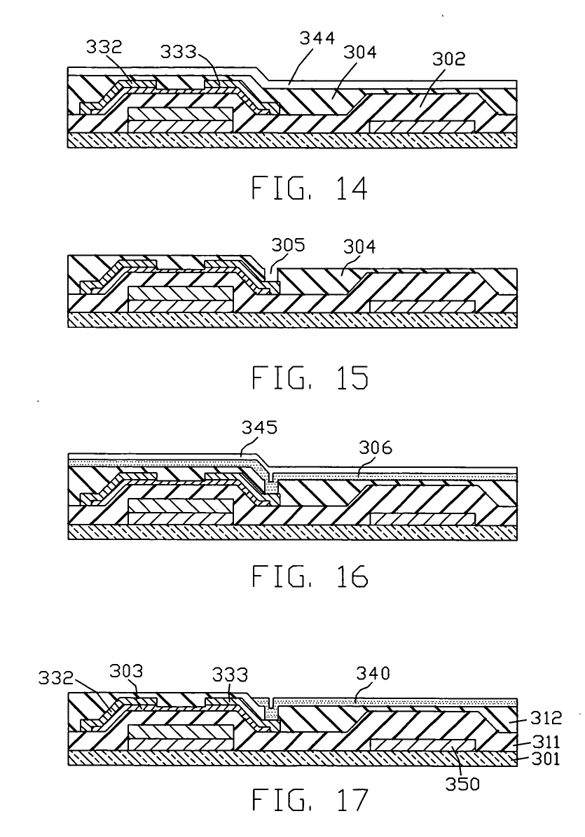

Referring to FIG. 14, a passivation layer 304 is deposited on the source 332, drain 333, and a gate insulating layer 302. A fourth photoresist layer 344 is formed on the passivation layer 304.

In step S17, a through hole is formed on the passivation layer 304.

Referring to FIG. 15, a fourth photo-mask is arranged above the fourth photoresist layer 344. An ultraviolet ray light source is used for developing the fourth photoresist layer 344 with the photo-mask to form a pattern with an opening, then, the passivation layer 304 is etched to form a through hole 305. Afterward, the fourth photoresist layer 344 is removed.

A fifth photo-mask process is described as follows.

In step S18, a transparent conductive metal layer is formed.

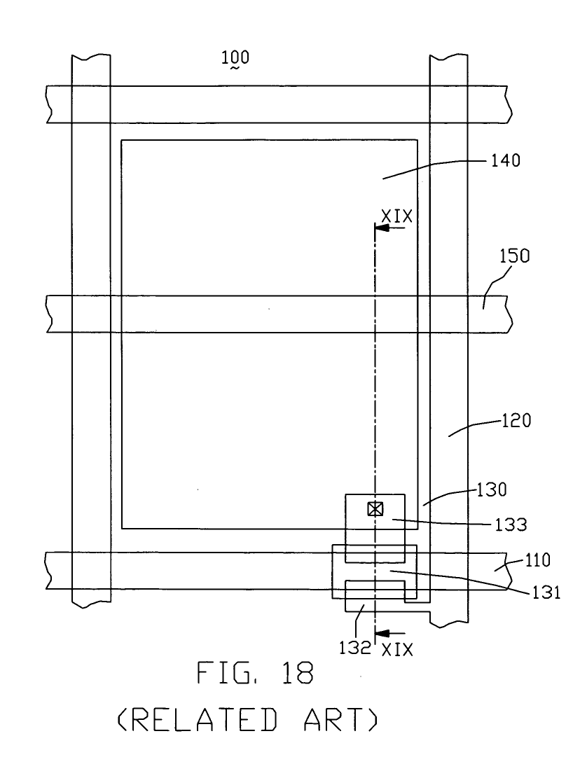

Referring to FIG. 16, a transparent and conductive metal layer 306 made from ITO is deposited on the passivation layer 304. The metal layer 306 is electrically connected to the drain 333 via the through hole 305. A fifth photoresist layer 345 is formed on the metal layer 306.

In a tenth step S19, a pixel electrode is formed.

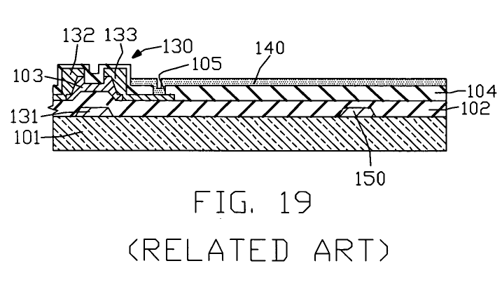

Referring to FIG. 17, a fifth photo-mask is arranged above the fifth photoresist layer 345. An ultraviolet ray light source is used for developing the fifth photoresist layer 345 with the fifth photo-mask to form a pattern, then, the metal layer 306 is etched to form a pixel electrode 340. Afterward, the fifth photoresist layer 345 is removed.

The storage line is made from silver, aluminum, or aluminum-neodymium alloy which has high reflection ability. The gate lines 210, 310 is a double-layer structure, and the second layers 212, 312 thereof made from silver, aluminum, or aluminum-neodymium alloy which does not chemically react with the connecting line made from ITO or IZO under normal temperatures. Therefore, chemical reaction between the gate lines 210, 310 and the connecting line can be avoided. In additional, the storage lines 250, 350 can reflect environment light; therefore, the brightness of the liquid crystal display is increased.

While preferred and exemplary embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A thin film transistor substrate of a liquid crystal display, comprising:
a substrate;
at least one gate line formed on the substrate;
at least one data line formed on the substrate;
at least one storage line formed on the substrate;
a gate insulating layer formed on the at least one gate line, the at least one storage line, and the substrate; and
a pixel electrode formed above the gate insulating layer;
wherein the at least one storage line cooperates with the pixel electrode to form a storage capacitor, and the at least one gate line comprises a first metal layer and a second metal layer formed on the first metal layer.

2. The thin film transistor substrate as claimed in claim 1, wherein the second metal layer is made from molybdenum, chromium, or titanium.

3. The thin film transistor substrate as claimed in claim 1, wherein the pixel electrode is made from indium tin oxide.

4. The thin film transistor substrate as claimed in claim 1, wherein the pixel electrode is made from indium zinc oxide.

5. The thin film transistor substrate as claimed in claim 1, wherein the first metal layer is made from silver, aluminum, or aluminum-neodymium alloy.

6. The thin film transistor substrate as claimed in claim 1, wherein the at least one storage line is made from silver, aluminum, or aluminum-neodymium alloy.

7. The thin film transistor substrate as claimed in claim 1, wherein a profile of the at least one storage line is equal to a profile of the first metal layer.

8. A method for fabricating a thin film transistor substrate, comprising:
providing a substrate;
forming a first metal layer on the substrate;
forming a second metal layer on the first metal layer;
forming a photoresist layer on the second metal layer;
developing the photoresist layer to form a patterned photoresist layer with different thicknesses, the patterned photoresist layer comprising a thinner portion and a thicker portion;
etching portions of the first and second metal layers not covered by the patterned photoresist layer;
etching the thinner portion of the patterned photoresist layer, such that the thicker portion of the patterned photoresist layer remains;
etching portions of the second metal layer not covered by the patterned photoresist layer; and
removing the residual patterned photoresist layer, so as to form a gate line comprised of the first metal layer and the second metal layer, and a storage line comprised of the first metal layer.

9. The method as claimed in claim 8, wherein the second metal layer is made from molybdenum, chromium, or titanium.

10. The method claimed in claim 8, wherein the first metal layer is made from silver, aluminum, or aluminum-neodymium alloy.

11. The method as claimed in claim 8, wherein the storage line is made from silver, aluminum, or aluminum-neodymium alloy.

12. The method as claimed in claim 8, further comprising forming a gate insulating layer on the substrate, the gate line, and the storage line.

13. The method as claimed in claim 12, further comprising forming a semiconductor layer on the gate insulating layer.

14. The method as claimed in claim 13, further comprising forming a source and a drain on the semiconductor layer.

15. The method as claimed in claim 14, further comprising forming a passivation layer on the source, the drain, and the gate insulating layer.

16. The method as claimed in claim 15, further comprising forming a pixel electrode on the passivation layer.
